(19) United States
(12) Patent Application Publication
(10) Pub. No.: US 2025/0290558 A1
(43) Pub. Date: Sep. 18, 2025

(54) BELT

(71) Applicant: BANDO CHEMICAL INDUSTRIES, LTD., Hyogo (JP)

(72) Inventor: Masato TAKAHARA, Kobe-shi, Hyogo (JP)

(73) Assignee: BANDO CHEMICAL INDUSTRIES, LTD., Hyogo (JP)

(21) Appl. No.: 18/863,335

(22) PCT Filed: May 8, 2023
(86) PCT No.: PCT/JP2023/017317

§ 371 Date: Nov. 6, 2024

(30) Foreign Application Priority Data
May 12, 2022 (JP) 2022-078975

(51) Int. Cl. F16G 1/12; F16G 1/28

(52) U.S. Cl. CPC F16G 1/12; F16G 1/28

(57) ABSTRACT

A belt according to one embodiment of the present invention includes: a belt main body; at least one energizing core cord including a conductive core wire; and at least one reinforcing core cord having a higher electrical resistance per unit length than the energizing core cord, wherein the energizing core cord and the reinforcing core cord are embedded, along a length direction of the belt main body, in the belt main body at an interval in a width direction thereof, the energizing core cord includes a coating film constituting a peripheral face and covering the core wire, and the coating film is fused with the belt main body.

### TECHNICAL FIELD

The present invention relates to a belt.

### BACKGROUND ART

Belts are sometimes used for lifting and/or transporting items in factories, warehouses, etc. In this case, for example, a carriage is fixed to a belt by means of a screw via a through-hole opened in the belt, and a pulley for driving the belt is rotated to move the carriage vertically or horizontally. The item put in the carriage is lifted and/or transported.

item from sliding off the carriage. This stopper may be electrically controlled to be housed, thereby preventing itself from becoming an obstacle at the time of loading the carriage with an item or unloading the item. In this manner, not a few carriages are provided with an additional function that is electrically controlled.

A belt in which a core cord also serves a wiring for power supply and/or an electrical signal for controlling such an additional function (hereinafter, also referred to simply as “wiring”) has been proposed (see Japanese Unexamined Patent Application, Publication No. 2019-60403). In this belt, the core cord is formed of a conductive material and thus also serves as a feeder cable, whereby the wiring can be embedded in the belt, while inhibiting an increase in the thickness of the belt.

### PRIOR ART DOCUMENTS

### Patent Documents

Patent Document 1: Japanese Unexamined Patent Application, Publication No. 2019-60403

### SUMMARY OF THE INVENTION

### Problems to be Solved by the Invention

In a belt including a core cord having such an energization function, a wiring is connected to the core cord having the energization function, and therefore, a tension may be applied to the core cord in a direction different from a moving direction of the belt. Hence, the core cord is likely to be separated from a belt main body, which may cause a problem in the belt.

The present invention was made in view of the foregoing problems, and an object of the present invention is to provide a belt which enables inhibiting separation of a core cord from a belt main body, even when the core cord is utilized as a wiring for an electrical signal and/or power supply.

### Means for Solving the Problems

A belt according to one embodiment of the present invention includes: a belt main body; at least one energizing core cord including a conductive core wire; and at least one reinforcing core cord having a higher electrical resistance per unit length than the energizing core cord, wherein the energizing core cord and the reinforcing core cord are embedded, along a length direction of the belt main body, in the belt main body at an interval in a width direction thereof, the energizing core cord includes a coating film constituting a peripheral face and covering the core wire, and the coating film is fused with the belt main body.

### Effects of the Invention

The belt of the present invention enables inhibiting separation of the core cord from the belt main body, even when the core cord is utilized as a wiring for an electrical signal and/or power supply.

### BRIEF DESCRIPTION OF THE DRAWINGS

FIG. 1 is a schematic perspective view illustrating a belt according to one embodiment of the present invention.

FIG. 2 is a schematic cross-sectional view taken along line A-A of the belt in FIG. 1.

FIG. 3 is a schematic cross-sectional view taken along line B-B of the belt in FIG. 1.

FIG. 4 is a schematic perspective view illustrating a reinforcing core cord in the vicinity of a belt hole of the belt in FIG. 1.

FIG. 5 is a schematic perspective view illustrating a reinforcing core cord in the vicinity of a belt hole, the reinforcing core cord having a configuration different from that in FIG. 4.

FIG. 6 is a schematic perspective view illustrating a belt according to an embodiment different from that in FIG. 1.

FIG. 7 is a schematic cross-sectional view of a belt according to an embodiment different from those in FIG. 3 and FIG. 6.

### DESCRIPTION OF EMBODIMENTS

### Description of Embodiments of the Present Invention

Firstly, embodiments of the present invention will be listed and described.

A belt according to one embodiment of the present invention includes: a belt main body; at least one energizing core cord including a conductive core wire; and at least one reinforcing core cord having a higher electrical resistance per unit length than the energizing core cord, wherein the energizing core cord and the reinforcing core cord are embedded, along a length direction of the belt main body, in the belt main body at an interval in a width direction thereof, the energizing core cord includes a coating film constituting a peripheral face and covering the core wire, and the coating film is fused with the belt main body.

In the belt, the energizing core cord includes the core wire and the coating film; therefore, when a wiring is connected to the energizing core cord, a tension applied to the core cord is conducted to both the core wire and the coating film. Of these, the coating film is fused with the belt main body, and thus, the tension acts in the same direction on both the belt main body and the energizing core cord. Accordingly, the belt enables inhibiting separation of the energizing core cord from the belt main body.

A principal component of the belt main body is preferably an elastomer, and a principal component of the coating film is preferably polyethylene or polyester. By thus using an elastomer as the principal component of the belt main body and using polyethylene or polyester as the principal component of the coating film, the coating film can be easily fused with the belt main body.

The elastomer is preferably a flame-retardant material. By thus using a flame-retardant material as the elastomer, ignition of the belt main body due to electric leakage or the like can be surely inhibited.

The belt preferably further includes a cover layer having a lower friction coefficient than the belt main body and covering one or both faces of the belt main body. By thus providing the cover layer having a low friction coefficient, the belt can be superior in abrasion resistance in use.

A principal component of the cover layer on at least one face is preferably a nylon resin or a fluorine resin. By thus using a nylon resin or a fluorine resin as the principal component of the cover layer, the friction coefficient of the cover layer can be reduced.

The belt preferably further includes a cover layer having a higher hardness than the belt main body and covering one or both faces of the belt main body. By thus providing the cover layer having a high hardness, the strength and/or abrasion resistance of the belt can be increased.

A principal component of the cover layer on at least one face is preferably a thermoplastic elastomer resin. By thus using a thermoplastic elastomer resin as the principal component of the cover layer, the belt main body and the cover layer can be made less likely to be separated from each other.

A JIS-A hardness of the belt main body is preferably no less than 70 and less than 100. By thus setting the JIS-A hardness of the belt main body to fall within the above range, the transmission efficiency can be increased, while inhibiting a decrease in the strength.

The belt main body preferably includes a core support portion on at least one face thereof, the core support portion being a depression for supporting the energizing core cord and the reinforcing core cord, and the core support portion is preferably covered. By thus including the core support portion, embedded positions of the energizing core cord and the reinforcing core cord at a time of manufacturing the belt can be easily controlled. Furthermore, by covering the core support portion, the energizing core cord can be prevented from being short-circuited to another conductor at a time of using the belt.

Each of core cords positioned on outermost sides in the width direction is preferably the reinforcing core cord. The electrical resistance of the core cords positioned on the outermost sides in the width direction may be increased over time by abrasion or the like due to friction from side faces of the belt. Thus, by using each of the core cords positioned on the outermost sides in the width direction not as a wiring for an electrical signal or power supply but as the reinforcing core cord, the reliability as a wiring can be increased.

The at least one energizing core cord preferably includes a plurality of energizing core cords, and the reinforcing core cord is preferably disposed between the energizing core cords adjacent to each other. By thus disposing the reinforcing core cord between the energizing core cords adjacent to each other, a local decrease in the strength of the belt can be inhibited.

The at least one energizing core cord preferably includes a plurality of energizing core cords, and a core cord group is preferably formed by no less than 2 and no greater than 5 energizing core cords consecutively adjacent to one another. By thus configuring the core cord group, for example, the energizing core cords can be easily connected in parallel to a wiring required to have a low resistance, such as a power supply wiring or the like. Furthermore, in a case in which the energizing core cords connected in parallel are used for the same signal, an average interval between the energizing core cords constituting the core cord group can be narrowed, enabling further inhibiting an increase in the width of the belt.

The core wire of the energizing core cord is preferably an annealed copper wire or a copper alloy wire. Copper has a low electrical resistance per unit length and is thus suitable for the energization purpose. Furthermore, since an annealed copper wire and a copper alloy wire are easy to bend, the occurrence of a problem such as disconnection or the like can be inhibited.

The core wire of the energizing core cord is preferably a single wire, a collective stranded wire, or a rope stranded wire. By using a single wire as the core wire of the energizing core cord, a cross section of the core is closest packed, and thus, the resistance of the core wire can be easily reduced. Furthermore, by using a collective stranded wire or a rope stranded wire as the core wire of the energizing core cord, the strength of the core can be increased to inhibit the occurrence of a problem such as disconnection or the like, and in addition, the bending fatigue resistance of the belt can be improved.

The energizing core cord is preferably a shield wire, a cable, or a shielded cable. By thus using a shield wire, a cable, or a shielded cable as the energizing core cord, the noise immunity of the energizing core cord can be improved.

The belt main body preferably has at least one belt hole penetrating the belt main body in a thickness direction. By thus providing the at least one belt hole in the belt main body, the belt can be easily fixed to a carriage or the like.

The energizing core cord preferably has a connector on at least one end side thereof. By thus providing the connector on at least one end side of the energizing core cord, the belt can be easily wired to another device.

The belt is preferably a flat belt. The belt can be suitably used as a flat belt which needs an energization function.

The belt is preferably a toothed belt including a plurality of teeth provided on one face of the belt main body at regular intervals in the length direction. The belt can be suitably used as a toothed belt which needs an energization function.

As referred to herein, the “principal component” means a component having the highest content, preferably a component having a content of no less than 50% by mass, and more preferably a component having a content of no less than 90% by mass. The “JIS-A hardness” means a hardness measured in accordance with JIS-K-7312:1996 (method A) by pressing a push needle of a type A durometer against a fixed belt surface.

Furthermore, the “friction coefficient” means a value measured by the following procedure. A test specimen having a size of 5 cm×15 cm is cut out from the belt. The test specimen is fixed to a static friction coefficient tester (for example, static friction tester TYPE:10, manufactured by Shinto Scientific Co., Ltd.). Cold-rolled steel is fixed on the test specimen, a stage of the tester is lifted, and a scale is read when the cold-rolled steel is moved; this value is defined as a friction coefficient value.

### Details of Embodiments of the Present Invention

The belt according to the one embodiment of the present invention will be described with reference to the drawings.

### First Embodiment

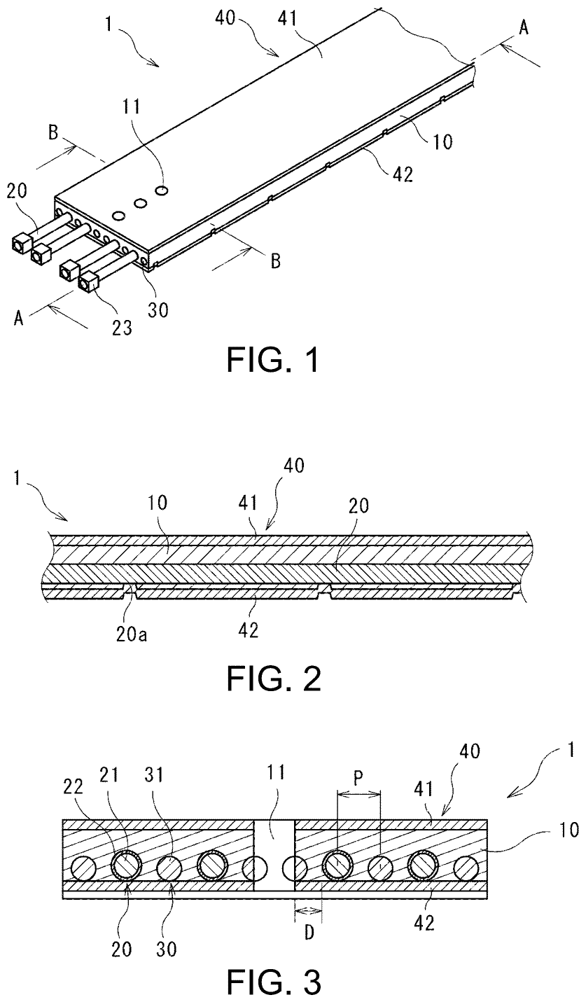

A belt 1 illustrated in FIGS. 1 to 3 includes a belt main body 10, four energizing core cords 20, six reinforcing core cords 30, and a cover layer 40. The belt 1 is a flat belt. The belt 1 can be suitably used as a flat belt which needs an energization function.

Furthermore, the belt main body 10 has at least one (in FIG. 1, three) belt hole 11 penetrating the belt main body 10 in a thickness direction, and the energizing core cords 20 and the reinforcing core cords 30 are embedded, along a length direction of the belt main body 10, in the belt main body 10 at intervals in a width direction thereof.

### Belt Main Body

A principal component of the belt main body 10 is a rubber or a resin. Examples of the rubber include: ethylene-α-olefin rubbers such as ethylene-propylene rubber (EPR) and ethylene propylene diene monomer rubber (EPDM); chloroprene rubber (CR); chlorosulfonated polyethylene rubber (CSM); hydrogenated nitrile rubber (H-NBR); and the like. The rubber may be one type of these rubbers or may be a mixture of two or more types. Examples of the resin include polyester, polyamide, polyurethane, and the like, which have thermoplastic properties.

In particular, the principal component of the belt main body 10 is preferably an elastomer such as ethylene-α-olefin rubber, thermoplastic polyurethane, polyamide, or polyester, and more preferably thermoplastic urethane, polyamide, or polyester. Thermoplastic urethane has low dust-generation properties and superior abrasion resistance. Polyamide is superior in oil resistance, chemical resistance, and abrasion resistance. Polyester is superior in water resistance, low-temperature flexibility, strength, and fatigue resistance. Furthermore, the elastomer is preferably a flame-retardant material. By thus using a flame-retardant material as the elastomer, ignition of the belt main body 10 due to electric leakage or the like can be surely inhibited.

An average thickness of the belt main body 10 is appropriately determined in accordance with the strength and the like required for the belt 1 and may be, for example, no less than 1 mm and no greater than 10 mm.

The width and length of the belt main body 10 are appropriately determined in accordance with the intended use of the belt 1. It is to be noted that the belt 1 is mainly used as an open belt having both ends.

The lower limit of a JIS-A hardness of the belt main body 10 is preferably 70 and more preferably 75. On the other hand, the JIS-A hardness of the belt main body 10 is preferably less than 100, more preferably less than 95, and still more preferably less than 80. When the JIS-A hardness of the belt main body 10 is less than the lower limit, the strength of the belt main body 10 and accordingly the strength of the belt 1 may be insufficient. Conversely, when the JIS-A hardness of the belt main body 10 is greater than the upper limit, the transmission efficiency of the belt 1 may be decreased.

As illustrated in FIGS. 1 and 2, in the belt 1, the belt main body 10 includes, on one face (driving face) thereof, a plurality of core support portions 20a being depressions for supporting the energizing core cords 20 and the reinforcing core cords 30. At a time of manufacturing the belt 1, for example, the belt main body 10 can be manufactured by extrusion, while the energizing core cords 20 and the reinforcing core cords 30 are supported by the plurality of core support portions 20a. In other words, by thus including the core support portions 20a, embedded positions of the energizing core cords 20 and the reinforcing core cords 30 at the time of manufacturing the belt 1 can be easily controlled.

The core support portions 20a are preferably covered. In the belt 1, the core support portions 20a are covered with a second cover layer 42 described later. By covering the core support portions 20a, the energizing core cords 20 can be prevented from being short-circuited to another conductor at a time of using the belt 1.

The belt main body 10 may contain a variety of additives. Examples of such an additive include an antioxidant, a thermal stabilizer, a light stabilizer, an antifogging agent, a flame retardant, a surface conditioner, a pigment, a filler, wax, and the like.

The belt hole 11 is used to fix a connection object such as a carriage or the like to the belt 1, and specifically, for example, a screw is inserted and fastened to the belt 1. A cross-sectional shape of the belt hole 11 is not particularly limited and is typically circular. Hereinafter, description is made on the premise that the belt hole 11 has a circular cross section; however, other shapes are not excluded.

Although the number of belt holes 11 may be one, a plurality of belt holes 11 are preferably provided to inhibit the rotation of the connection object. Furthermore, depending on a weight of the connection object, the number of belt holes 11 may be no less than three. Alternatively, to enable adjusting an attachment position, the number of belt holes 11 to be provided may be greater than the number of sites fastened to the connection object.

The belt hole 11 is preferably provided in a central portion in the width direction of the belt main body 10. By providing the belt hole 11 in the central portion in the width direction of the belt main body 10, the connection object can be stably connected.

Furthermore, the belt hole 11 is typically provided at one end or both ends in the length direction of the belt main body 10. This is because in most cases, the connection object is connected to the end(s) in the length direction of the belt main body 10.

In the case in which the plurality of belt holes 11 are provided, the plurality of belt holes 11 are arranged such that centers thereof are aligned along the length direction. A distance between the belt holes 11 adjacent to each other is appropriately determined such that the connection object can be fastened. The plurality of belt holes 11 are preferably arranged at regular intervals. By thus arranging the plurality of belt holes 11 at regular intervals, a pressure applied to the belt main body 10 at the time of fastening the connection object can be uniformly dispersed, enabling inhibiting damage of the belt main body 10 due to a local pressure concentration.

The lower limit of a diameter of the belt hole 11 is preferably 2 mm and more preferably 3 mm. On the other hand, the upper limit of the diameter of the belt hole 11 is preferably 7 mm and more preferably 6 mm. When the diameter of the belt hole 11 is less than the lower limit, sufficient fastening strength with respect to the connection object may not be ensured. Conversely, when the diameter of the belt hole 11 is greater than the upper limit, the strength of the belt main body 10 in the vicinity of the belt hole 11 may be insufficient, and/or a sufficient number of energizing core cords 20 may not be ensured.

### Energizing Core Cord

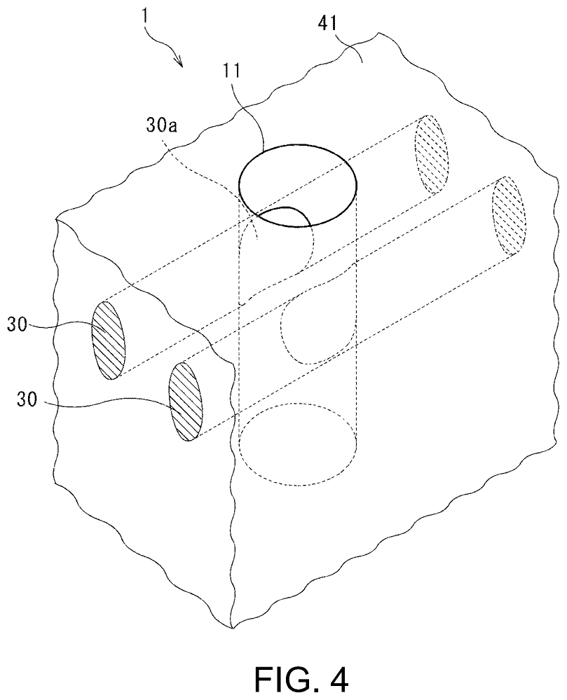

Each of the energizing core cords 20 is a linear object and has, for example, a circular cross section. As illustrated in FIG. 3, the energizing core cord 20 includes: a conductive core wire 21; and a coating film 22 constituting a peripheral face and covering the core wire 21.

Furthermore, as illustrated in FIG. 1, the energizing core cord 20 preferably has a connector 23 on at least one end side thereof. The connector 23 is a member for connecting the energizing core cord 20 to a signal line outside the belt 1. By thus providing the connector 23 on at least one end side of the energizing core cord 20, the belt 1 can be easily wired to another device. It is to be noted that the connector 23 may be provided on both ends of the energizing core cord 20.

The energizing core cord 20 is preferably a shield wire, a cable, or a shielded cable. By thus using a shield wire, a cable, or a shielded cable as the energizing core cord 20, the noise immunity of the energizing core cord 20 can be improved.

The lower limit of an average diameter of the energizing core cord 20 is preferably 0.2 mm, more preferably 0.5 mm, and still more preferably 1 mm. On the other hand, the upper limit of the average diameter of the energizing core cord 20 is preferably 2.5 mm and more preferably 1.5 mm. When the average diameter of the energizing core cord 20 is less than the lower limit, the electrical resistance of the energizing core cord 20 cannot be sufficiently lowered, resulting in that the energizing core cord 20 may not sufficiently fulfill the function as an electrical signal or a power supply. Conversely, when the average diameter of the energizing core cord 20 is greater than the upper limit, the width of the belt 1 may be too large. As referred to herein, the “average diameter” means an average value of diameters measured at ten arbitrary points. Hereinafter, the same applies to all “averages.” In other words, the term “average” means an average calculated from values measured at ten arbitrary points of a measurement object.

### Core Wire

The core wire 21 can be exemplified by a steel wire, a copper wire, or the like. Of these, a copper wire is preferred, and an annealed copper wire or a copper alloy wire is more preferred. A copper wire has a low electrical resistance per unit length and is thus suitable for the energization purpose. Furthermore, since an annealed copper wire and a copper alloy wire are easy to bend, the occurrence of a problem such as disconnection or the like can be inhibited.

The core wire 21 of the energizing core cord 20 is preferably a single wire, a collective stranded wire, or a rope stranded wire. By using a single wire as the core wire 21 of the energizing core cord 20, a cross section of the core wire 21 is closest packed, and thus, the resistance of the core wire 21 can be easily reduced. Furthermore, by using a collective stranded wire or a rope stranded wire as the core wire 21 of the energizing core cord 20, the strength of the core wire 21 can be increased to inhibit the occurrence of a problem such as disconnection or the like, and in addition, the bending fatigue resistance of the belt 1 can be improved.

### Coating Film

The coating film 22 is preferably constituted by an insulator. The insulator thus constituting the coating film 22 can inhibit a change in electrical characteristics when the energizing core cord 20 comes in contact with another energizing core cord 20 or the like. Furthermore, the belt 1 is manufactured while supporting the energizing core cord 20 from below, and therefore, as illustrated in FIG. 2, the belt 1 manufactured may include, at the support point, the core support portion 20a in which a part of the energizing core cord 20 is exposed from the belt main body 10. Even when the core support portion 20a exists in this manner, the coating film 22 constituted by the insulator can prevent a short circuit and/or electrical shock in the case in which current flows through the energizing core cord 20.

The coating film 22 is fused with the belt main body 10. That is to say, while the coating film 22 keeps its original shape, the belt main body 10 and the coating film 22 are heated and melted to be welded together at an interface therebetween.

A melting point of a principal component of the coating film 22 is preferably lower than a melting point of the principal component of the belt main body 10. By thus setting the melting point of the principal component of the coating film 22 to be lower than the melting point of the principal component of the belt main body 10, a forming temperature of the belt 1 during the manufacture can be set to be no less than a melting point of the coating film 22, thereby surely fusing the coating film 22.

In the case in which the principal component of the belt main body 10 is an elastomer, the principal component of the coating film 22 is preferably polyethylene or polyester. By thus using an elastomer as the principal component of the belt main body 10 and using polyethylene or polyester as the principal component of the coating film 22, the coating film 22 can be easily fused with the belt main body 10.

### Relation to Belt Hole

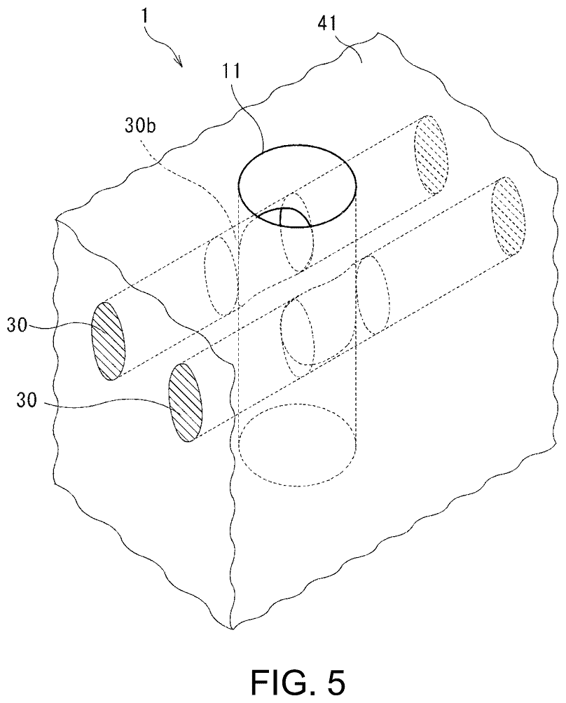

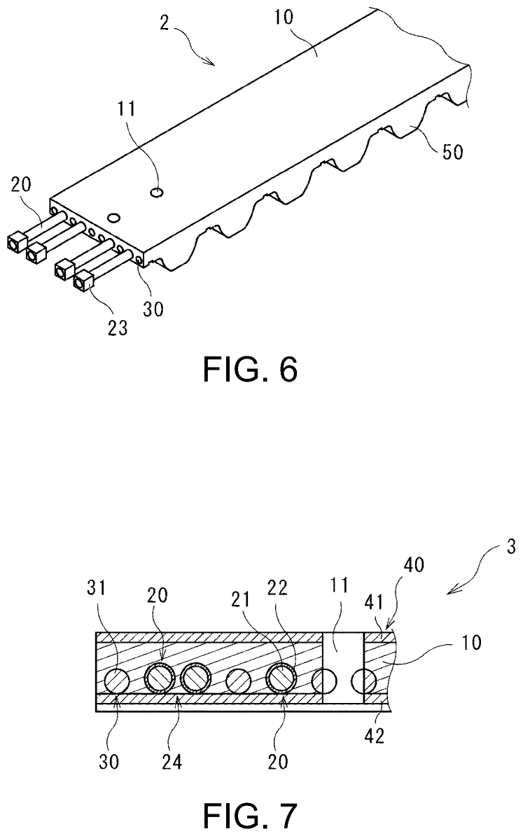

As illustrated in FIG. 3, the belt hole 11 may be provided on the reinforcing core cord 30 described later. In other words, the reinforcing core cord 30 may be cut off by the belt hole 11. In this case, of the reinforcing core cord 30, a part exposed in the belt hole 11 (cut-off part 30a in FIG. 4) may be scraped off as illustrated in FIG. 4, or of the reinforcing core cord 30, a part corresponding to the belt hole 11 (cut-off part 30b in FIG. 4) may be cut as illustrated in FIG. 5. In both cases, the reinforcing core cord 30 reinforces a region which is not provided with the belt hole 11. On the other hand, the belt hole 11, which causes a loss of electrical connection, cannot be provided on the energizing core cord 20. Conversely, the energizing core cord 20 is provided so as to avoid the belt hole 11.

Now consider a distance by which the energizing core cord 20 is separated from the belt hole 11. A screw is inserted into the belt hole 11 to fasten the connection object to the belt 1. A diameter of an upper face portion of the screw is structurally greater than the diameter of the belt hole 11; therefore, when the screw is tightened to fix the connection object to the belt 1, the upper face portion of the screw is pressed against the belt 1. At this time, if the energizing core cord 20 is disposed in a region close to the upper face portion of the screw, this pressing pressure may cause a change in the resistance value of the energizing core cord 20, and thus, desired electrical characteristics may not be obtained. Therefore, to prevent a change in the electrical characteristics due to the pressing force at the time of tightening the screw, the energizing core cord 20 needs to be separated at a certain distance from the belt hole 11. Specifically, the lower limit of a distance between the energizing core cord 20 and a periphery of the belt hole 11 (distance D in FIG. 3) is preferably 0.5 mm and more preferably 0.7 mm. On the other hand, the upper limit of the distance D is not particularly limited; in light of the fact that when the distance D is too large, a necessary number of energizing core cords 20 may not be arranged, the upper limit of the distance D may be, for example, 5 mm.

### Reinforcing Core Cord

Each of the reinforcing core cords 30 is a linear object and has, for example, a circular cross section. The reinforcing core cord 30 includes a core wire 31 and has a higher electrical resistance per unit length than the energizing core cord 20.

The core wire 31 of the reinforcing core cord 30 may be formed using the same material as the core wire 21 of the energizing core cord 20; however, the core wire 31 of the reinforcing core cord 30 is preferably formed using a material different from that of the core wire 21 of the energizing core cord 20. By thus making the core wire 31 of the reinforcing core cord 30 to be different from the core wire 21 of the energizing core cord 20, a core wire having a low electrical resistivity can be employed as the core wire 21 of the energizing core cord 20, whereby the number of parallel connections of the energizing core cords 20 for ensuring necessary electrical resistance can be easily reduced. In particular, a copper wire having a low electrical resistivity is preferably used as the core wire 21 of the energizing core cord 20, and an aramid wire having an insulating property is preferably used as the core wire 31 of the reinforcing core cord 30.

Furthermore, in a case in which the core wire 31 of the reinforcing core cord 30 is conductive, a copper wire coated with the coating film 22 having an insulating property is preferably used as the core wire 21 of the energizing core cord 20, and a steel wire is preferably used as the core wire 31 of the reinforcing core cord 30. A steel wire is highly rigid and can maintain the strength even with a small diameter. The reinforcing core cord 30 may be configured not to include an insulating layer (coating film). Since the energizing core cord 20 includes the coating film 22, the function of the energizing core cord 20 as an electrical signal or a power supply is less likely to be influenced even if a steel wire without an insulating layer comes in contact with the energizing core cord 20. Thus, since the reinforcing core cord 30 does not need to be provided with an insulating layer and can have a reduced diameter, space can be saved especially in the width direction. Accordingly, by using a steel wire as the core wire 31 of the reinforcing core cord 30, the strength of the belt 1 can be maintained while ensuring a wide region for providing the energizing core cord 20. As set forth above, by using, as the core wire 21 of the energizing core cord 20, a copper wire coated with the coating film 22 having an insulating property and using a steel wire as the core wire 31 of the reinforcing core cord 30, an increase in the width of the belt 1 can be further inhibited while ensuring the number of core cords necessary for wirings for an electrical signal and/or power supply.

The lower limit of an average diameter of the reinforcing core cord 30 is preferably 0.1 mm, more preferably 0.2 mm, and still more preferably 0.5 mm. On the other hand, the upper limit of the average diameter of the reinforcing core cord 30 is preferably 2 mm and more preferably 1 mm. When the average diameter of the reinforcing core cord 30 is less than the lower limit, the strength of the reinforcing core cord 30 may be insufficient. Conversely, when the average diameter of the reinforcing core cord 30 is greater than the upper limit, the belt 1 may be too heavy, the bending rigidity of the belt 1 may be too high to be wound on a pulley having a particularly small diameter, and/or the belt main body 10 for covering the reinforcing core cord 30 may be too thick.

Relation between Energizing Core Cord and Reinforcing Core Cord

The average diameter of the energizing core cord 20 is preferably greater than the average diameter of the reinforcing core cord 30. By thus setting the average diameter of the energizing core cord 20 to be greater than the average diameter of the reinforcing core cord 30, the electrical resistance per unit length of the energizing core cord 20 can be easily reduced. In particular, in the case in which a material of the energizing core cord 20 is the same as a material of the reinforcing core cord 30, the electrical resistance per unit length can be reduced by setting the average diameter of the energizing core cord 20 to be greater than the average diameter of the reinforcing core cord 30.

As illustrated in FIG. 3, the four energizing core cords 20 and the six reinforcing core cords 30 (also collectively referred to as “core cords”) are arranged such that the shortest distance from one face of the belt main body 10 to outer peripheries of the core cords is constant. Such an arrangement enables easily manufacturing the belt main body 10 by extrusion while supporting the ten core cords from below.

Each of core cords positioned on outermost sides in the width direction of the belt main body 10 is preferably the reinforcing core cord 30. The electrical resistance of the core cords positioned on the outermost sides in the width direction may be increased over time by abrasion or the like due to friction from side faces of the belt 1. Thus, by using each of the core cords positioned on the outermost sides in the width direction not as a wiring for an electrical signal or power supply but as the reinforcing core cord 30, the reliability as a wiring can be increased.

The lower limit of an average distance between a central axis of the reinforcing core cord 30 provided on the outermost side and a side face of the belt main body 10 approximate thereto (also referred to as “average distance between the reinforcing core cord 30 and the side face of the belt main body 10”) is preferably 0.3 mm and more preferably 0.5 mm. On the other hand, the upper limit of the average distance between the reinforcing core cord 30 and the side face of the belt main body 10 is preferably 1 mm and more preferably 0.7 mm. When the average distance between the reinforcing core cord 30 and the side face of the belt main body 10 is less than the lower limit, the reinforcing core cord 30 provided on the outermost side may be exposed from the side face of the belt main body 10 at the time of manufacturing the belt 1. Conversely, when the average distance between the reinforcing core cord 30 and the side face of the belt main body 10 is greater than the upper limit, side edges of the belt main body 10 are likely to flutter in operation, resulting in that an effect of improving the driving accuracy owing to the reinforcing core cord 30 may be insufficient.

In the belt 1, as illustrated in FIG. 3, the reinforcing core cord 30 is disposed between the energizing core cords 20 adjacent to each other. By thus disposing the reinforcing core cord 30 between the energizing core cords 20 adjacent to each other, a local decrease in the strength of the belt 1 can be inhibited.

The energizing core cords 20 and the reinforcing core cords 30 are preferably arranged symmetrically with respect to a center in the length direction of the belt main body 10. The belt 1 in operation is tensioned to be used; such a symmetric arrangement of the energizing core cords 20 and the reinforcing core cords 30 enables a tension to be uniformly applied in the width direction of the belt main body 10, thereby preventing the deviation of the belt 1 during running.

The lower limit of an average pitch P of the core cords adjacent to one another (sec FIG. 3; an average distance between central axes of the core cords adjacent to each other in the width direction of the belt 1) is preferably 0.3 mm and more preferably 0.5 mm. On the other hand, the upper limit of the average pitch P is preferably 4 mm and more preferably 1 mm. When the average pitch P is less than the lower limit, the insulation between the plurality of energizing core cords 20 may not be sufficiently ensured, and/or the flexibility of the belt 1 may be insufficient. Conversely, when the average pitch P is greater than the upper limit, the belt 1 may be unnecessarily expanded in the width direction, and/or effects of improving the strength, durability, driving accuracy, etc. of the belt 1 owing to the reinforcing core cords 30 may be insufficient. It is to be noted that in a case in which no core cord is disposed at a position overlapping with the belt hole 11, the average pitch P between two core cords arranged with the belt hole 11 interposed therebetween is not limited thereto.

The average pitch P is preferably a constant pitch regardless of the combination of types of the core cords adjacent to each other (the energizing core cord 20 and the reinforcing core cord 30). In other words, between the energizing core cords 20 adjacent to each other, between the reinforcing core cords 30 adjacent to each other, and between the energizing core cord 20 and the reinforcing core cord 30 adjacent to each other, the average pitch P is preferably equal regardless of the combination of the core cords adjacent to each other. By thus arranging the core cords at a regular pitch regardless of the types of the core cords, the occurrence of flutter of the belt main body 10 in operation can be inhibited. Furthermore, by equalizing the average pitch P, a uniform load is applied to each core cord; consequently, early disconnection and/or an increase in the electrical resistance of the energizing core cord 20 due to a load applied locally to a specific core wire cord can be prevented. It is to be noted that the expression that “the average pitch P is equal” encompasses the case of complete equality as well as cases of each average pitch P falling within a range of practical errors (for example, a range of errors of no greater than 5% from the central value).

### Cover Layer

In the belt 1, the cover layer 40 is constituted by: a first cover layer 41 covering a transport face of the belt main body 10; and the second cover layer 42 covering the driving face. That is to say, in the belt 1, the cover layer 40 covers both faces of the belt main body 10.

A friction coefficient of the cover layer 40 is preferably lower than a friction coefficient of the belt main body 10. By thus providing the cover layer 40 having a low friction coefficient, the belt 1 can be superior in abrasion resistance in use. Specifically, the friction coefficient of the cover layer 40 is preferably no less than 0.15 and no greater than 0.25.

In this case, a principal component of the cover layer 40 is preferably a nylon resin or a fluorine resin. By thus using a nylon resin or a fluorine resin as the principal component of the cover layer 40, the friction coefficient of the cover layer 40 can be reduced. Examples of the nylon resin include nylon 6.6. nylon 6, and the like. Examples of the fluorine resin include polytetrafluoroethylene (PTFE), perfluoroalkoxy alkane (PFA), and the like.

Furthermore, it is also preferred that a hardness of the cover layer 40 is higher than a hardness of the belt main body 10. By thus providing the cover layer 40 having a high hardness, the strength and/or abrasion resistance of the belt 1 can be increased. It is to be noted that in light of the effects, a JIS-A hardness of the cover layer 40 is preferably no less than 85 and no greater than 95.

In this case, the principal component of the cover layer 40 is preferably a thermoplastic elastomer resin. By thus using a thermoplastic elastomer resin as the principal component of the cover layer 40, the belt main body 10 and the cover layer 40 can be made less likely to be separated from each other. Examples of the thermoplastic elastomer resin include thermoplastic polyurethane (TPU) and the like.

The first cover layer 41 and the second cover layer 42 may be different in type. For example, the first cover layer 41 may be formed using a nylon resin or a fluorine resin to have a friction coefficient lower than the friction coefficient of the belt main body 10, and the second cover layer 42 may be formed using a thermoplastic elastomer resin to have a hardness higher than the hardness of the belt main body 10.

The lower limit of an average thickness of the cover layer 40 is preferably 15 μm and more preferably 25 μm. On the other hand, the upper limit of the average thickness of the cover layer 40 is preferably 3,000 um and more preferably 2,000 μm. When the average thickness of the cover layer 40 is less than the lower limit, the cover layer 40 may be likely to be torn. Conversely, when the average thickness of the cover layer 40 is greater than the upper limit, the rigidity of the belt 1 may be too high. It is to be noted that although an average thickness of the first cover layer 41 may be different from an average thickness of the second cover layer 42, these average thicknesses are preferably equal in light of warpage of the belt 1.

### Method for Manufacturing Belt

The belt 1 can be manufactured, for example, by a manufacturing method including an extruding step and a cover layer-laminating step.

### Extruding Step

In the extruding step, an extruded body which contains a rubber or a resin composition as a principal component and in which the energizing core cords 20 and the reinforcing core cords 30 are embedded is formed by extrusion.

Specifically, the plurality of core cords (the energizing core cords 20 and the reinforcing core cords 30) are inserted into a crosshead attached to a cylinder tip of an extruder, and while supporting with the core support portions 20a, the rubber or the resin composition which is melted is extruded to cover both sides of the plurality of core cords. Alternatively, the rubber or the resin composition which has been subjected to melt extrusion and the plurality of core cords may be pressed between a pair of rolls, whereby the plurality of core cords are embedded in the rubber or the resin composition. This rubber or resin composition constitutes the belt main body 10.

In the extrusion, a heating temperature for melting the rubber or the resin composition depends on the type of the rubber or the resin, whether a hardener is used, and/or the like, and the lower limit of the heating temperature is preferably 150° C. On the other hand, the upper limit of the heating temperature is preferably 250° C. When the heating temperature is less than the lower limit, the rubber or the resin composition may not be sufficiently melted, making the extrusion difficult. Conversely, when the heating temperature is greater than the upper limit, the extruded body becomes unnecessarily hot and thus the cooling time is unnecessarily prolonged, which may lead to a decrease in the manufacturing efficiency of the belt 1. Furthermore, in order to allow the coating film 22 to be fused with the belt main body 10 by this heating, the maximum value of the heating temperature is set to a temperature higher than the melting point of the coating film 22.

The belt main body 10 can be obtained by cooling the extruded body.

### Cover Layer-Laminating Step

In the cover layer-laminating step, the cover layer 40 is laminated on the both faces of the belt main body 10 obtained in the extruding step.

The cover layer 40 can be laminated in the following manner: at the time of forming the belt main body 10 in the extruding step, the cover layer 40 in a thin-film shape is fed from an upper side, a lower side, or both sides of the belt main body 10 and, for example, inserted between the belt main body 10 and the roll(s) to be interposed therebetween.

Next, the laminate including the belt main body 10 and the cover layer 40 laminated thereon is cooled. Examples of a cooling method include air cooling, water cooling, and the like. Conditions involving the temperature and time of the cooling are not particularly limited, and examples of setting conditions include conditions under which an internal temperature of the laminate to be formed can be lowered to no less than 10° C. and no greater than 40° C.

In the above-described manner, the belt 1 can be manufactured.

### Advantages

In the belt 1, the energizing core cord 20 includes the core wire 21 and the coating film 22; therefore, when a wiring is connected to the energizing core cord 20, a tension applied to the core cord is conducted to both the core wire 21 and the coating film 22. Of these, the coating film 22 is fused with the belt main body 10, and thus, the tension acts in the same direction on both the belt main body 10 and the energizing core cord 20. Accordingly, the belt 1 enables inhibiting separation of the energizing core cord 20 from the belt main body 10.

### Second Embodiment

A belt 2 illustrated in FIG. 4 includes: the belt main body 10; a plurality of teeth 50 provided on one face of the belt main body 10 at regular intervals in the length direction; the four energizing core cords 20 each including the conductive core wire 21; and the six reinforcing core cords 30 each having a higher electrical resistance per unit length than the energizing core cord 20, wherein the energizing core cords 20 and the reinforcing core cords 30 are embedded, along the length direction of the belt main body 10, in the belt main body 10 at intervals in the width direction thereof, each of the energizing core cords 20 includes the coating film 22 constituting a peripheral face and covering the core wire 21, and the coating film 22 is fused with the belt main body 10. The belt 2 is a toothed belt.

The belt 2 can have the same configuration as the belt 1 illustrated in FIG. 1, except that the teeth 50 are provided and that the cover layer 40 is not provided; therefore, the same reference symbols are used, and detailed description thereof is omitted. It is to be noted that in the belt 2. the belt hole 11 may be provided between the teeth 50 as illustrated in FIG. 4 but may also be provided to penetrate one of the teeth 50. Furthermore, an interval between the belt holes 11 in the case in which a plurality of belt holes 11 are included may agree with an interval between the teeth 50 as illustrated in FIG. 4 or may not agree therewith.

### Teeth

Each of the teeth 50 is a protruding portion having a cross section in a trapezoidal shape, a triangle shape, a semicircular shape, a chevron shape, a wave shape, a shape like a normal distribution curve, etc. Furthermore, each of the teeth 50 is provided such that a ridgeline (axis direction) thereof agrees with the width direction of the belt main body 10.

An average height of the teeth 50 and a pitch between the teeth 50 are appropriately determined in accordance with the intended use of the belt 2. The average height of the teeth 50 may be, for example, no less than 1.0 mm and no greater than 10 mm. Furthermore, the pitch between the teeth 50 may be, for example, no less than 2 mm and no greater than 25 mm.

A principal component of the teeth 50 may be similar to that of the belt main body 10. Furthermore, the teeth 50 may contain additive(s) similar to that/those of the belt main body 10.

### Advantages

The belt 2 can be suitably used as a toothed belt which needs an energization function.

### Other Embodiments

The present invention is not limited to the above embodiments and can be implemented, besides the above modes, in variously modified or improved modes.

In the above embodiments, the case in which the belt of the present invention includes four energizing core cords and six reinforcing core cords has been described as an example; however, with regard to the energizing core cord and the reinforcing core cord, the number of cords is not limited thereto, and the energizing core cord and the reinforcing core cord may each be constituted by an arbitrary number (at least one) of cords. The number of energizing core cords is appropriately determined in accordance with a necessary number of wirings for an electrical signal and/or power supply, and the number of reinforcing core cords is appropriately determined in accordance with the strength necessary for the belt.

In the above embodiments, the case in which the belt main body has at least one belt hole penetrating the belt main body in the thickness direction has been described; however, the belt hole is not an essential component, and a belt without a belt hole is also intended by the present invention.

In the above embodiments, the case in which the belt main body includes the core support portion on one face thereof has been described; however, the belt main body may be configured to include the core support portions on the both faces of the belt main body, or conversely, a configuration without the core support portion may also be employed.

In the first embodiment, the case in which the cover layer covers the both faces of the belt main body has been described; however, a configuration in which the cover layer covers only one of the transport face and the driving face may also be employed. Furthermore, a belt without the cover layer is also intended by the present invention.

In the second embodiment, the toothed belt without the cover layer has been described; however, the belt may include a cover layer covering one or both faces of the belt main body. In this case, the cover layer may have a configuration similar to that of the cover layer of the first embodiment.

In the above embodiments, the case in which the energizing core cord has the connector on at least one end side thereof has been described; however, a belt in which the energizing core cord does not have the connector is also intended by the present invention.

In the above embodiments, the configuration in which the reinforcing core cord is disposed between the energizing core cords adjacent to each other has been described; however, the arrangement of the energizing core cords and the reinforcing core cords is not limited thereto. As in a belt 3 illustrated in FIG. 5, a core cord group 24 may be formed by the energizing core cords 20 consecutively adjacent to one another. By thus configuring the core cord group 24, for example, the energizing core cords can be easily connected in parallel to a wiring required to have a low resistance, such as a power supply wiring or the like. It is to be noted that the belt 3 can have the same configuration as the belt 1 illustrated in FIG. 3, except that the core cord group 24 is formed; therefore, the same reference symbols are used for the corresponding components, and detailed description thereof is omitted.

The number of energizing core cords 20 constituting the core cord group 24 is preferably no less than 2 and no greater than 5. When the number is less than the lower limit, the core cord group 24 cannot be formed. Conversely, when the number is greater than the upper limit, the interval between the reinforcing core cords 30 of the core cord group 24 may be too large, leading to a decrease in the strength in the vicinity of the core cord group 24.

An average interval between the energizing core cords 20 constituting the core cord group 24 is preferably smaller than an average interval between the energizing core cord 20 and the reinforcing core cord 30. In a case in which the energizing core cords 20 connected in parallel are used for the same signal, the average interval between the energizing core cords 20 constituting the core cord group 24 can be narrowed, enabling further inhibiting an increase in the width of the belt 3.

In the belt 3 illustrated in FIG. 5, the core cord group 24 is provided at one site; however, the core cord group 24 may be provided at a plurality of sites. Furthermore, as illustrated in FIG. 5, an isolated energizing core cord 20 which does not belong to any core cord group 24 may be provided, or all the energizing core cords 20 may belong to any of the core cord groups 24.

### INDUSTRIAL APPLICABILITY

The belt of the present invention enables inhibiting an increase in the width, while ensuring the number of core cords necessary for wirings for an electrical signal and/or power supply.

### EXPLANATION OF THE REFERENCE SYMBOLS

1, 2, 3 belt
10 belt main body
11 belt hole
20 energizing core cord
20a core support portion
21 core wire
22 coating film
23 connector
24 core cord group
30 reinforcing core cord
30a, 30b cut-off part
31 core wire
40 cover layer
41 first cover layer
42 second cover layer
50 teeth
D distance
P average pitch

1. A belt comprising:
a belt main body;
at least one energizing core cord comprising a conductive core wire; and
at least one reinforcing core cord having a higher electrical resistance per unit length than the energizing core cord, wherein
the energizing core cord and the reinforcing core cord are embedded, along a length direction of the belt main body, in the belt main body at an interval in a width direction thereof,
the energizing core cord comprises a coating film constituting a peripheral face and covering the core wire, and
the coating film is fused with the belt main body.

2. The belt according to claim 1, wherein
a principal component of the belt main body is an elastomer, and
a principal component of the coating film is polyethylene or polyester.

3. The belt according to claim 2, wherein the elastomer is a flame-retardant material.

4. The belt according to claim 1, further comprising a cover layer having a lower friction coefficient than the belt main body and covering one or both faces of the belt main body.

5. The belt according to claim 4, wherein a principal component of the cover layer on at least one face is a nylon resin or a fluorine resin.

6. The belt according to claim 1, further comprising a cover layer having a higher hardness than the belt main body and covering one or both faces of the belt main body.

7. The belt according to claim 6, wherein a principal component of the cover layer on at least one face is a thermoplastic elastomer resin.

8. The belt according to claim 1, wherein a JIS-A hardness of the belt main body is no less than 70 and less than 100.

9. The belt according to claim 1, wherein
the belt main body comprises a core support portion on at least one face thereof, the core support portion being a depression for supporting the energizing core cord and the reinforcing core cord, and
the core support portion is covered.

10. The belt according to claim 1, wherein each of core cords positioned on outermost sides in the width direction is the reinforcing core cord.

11. The belt according to claim 1, wherein
the at least one energizing core cord comprises a plurality of energizing core cords, and
the reinforcing core cord is disposed between the energizing core cords adjacent to each other.

12. The belt according to claim 1, wherein
the at least one energizing core cord comprises a plurality of energizing core cords, and
a core cord group is formed by no less than 2 and no greater than 5 energizing core cords consecutively adjacent to one another.

13. The belt according to claim 1, wherein the core wire of the energizing core cord is an annealed copper wire or a copper alloy wire.

14. The belt according to claim 1, wherein the core wire of the energizing core cord is a single wire, a collective stranded wire, or a rope stranded wire.

15. The belt according to claim 1, wherein the energizing core cord is a shield wire, a cable, or a shielded cable.

16. The belt according to claim 1, wherein the belt main body comprises at least one belt hole penetrating the belt main body in a thickness direction.

17. The belt according to claim 1, wherein the energizing core cord comprises a connector on at least one end side thereof.

18. The belt according to claim 1, wherein the belt is a flat belt.

19. The belt according to claim 1, wherein the belt is a toothed belt comprising a plurality of teeth provided on one face of the belt main body at regular intervals in the length direction.
